(19) United States
(12) Patent Application Publication
(10) Pub. No.: US 2026/0303501 A1
(43) Pub. Date: Oct. 1, 2026

(54) RADIO POWER MANAGEMENT FOR NETWORK DEVICES

(71) Applicant: Juniper Networks, Inc., Sunnyvale, CA (US)

(72) Inventors: Wenfeng Wang, Sunnyvale, CA (US); Ishan Singh, Mountain View, CA (US); Jacob Thomas, Saratoga, CA (US); May Zar Lin, Gilroy, CA (US)

(21) Appl. No.: 19/554,219

(22) Filed: Mar. 2, 2026

Related U.S. Application Data
(60) Provisional application No. 63/780,523, filed on Mar. 31, 2025.

(51) Int. Cl. H04L 43/0882; H04B 17/309; H04L 41/16; H04W 52/36

(52) U.S. Cl. CPC H04L 43/0882; H04B 17/346; H04L 41/16; H04W 52/367

(57) ABSTRACT

Techniques are disclosed for a network management system (NMS) that manages radio and/or antenna power of network devices, such as access points (APs), in a network. In some examples, the network comprises a high-density (HD) mesh network or an ultra-high density (UHD) mesh network. Each of the APs in a network collects metrics of utilization and interference, and uploads the metrics to a cloud orchestrator or NMS. The NMS determines an amount of resources to be used by the network. The NMS provides the metrics of utilization and interference for the APs and the determined amount of resources to an artificial intelligence (AI) model to obtain values of a radio power to be used by each corresponding AP. The NMS configures each of the APs with the corresponding determined value for the radio power, so as to improve performance of the network.

This application claims the benefit of U.S. Provisional Application No. 63/780,523 which was filed on Mar. 31, 2025, the entire content of which is incorporated herein by reference.

### BACKGROUND

Commercial premises or sites, such as offices, hospitals, airports, stadiums, or retail outlets, often install complex wireless network systems, including a network of wireless access points (APs), throughout the premises to provide wireless network services to one or more wireless client devices (or simply, “clients”). APs are physical, electronic devices that enable other devices to wirelessly connect to a wired network using various wireless networking protocols and technologies, such as wireless local area networking protocols conforming to one or more of the IEEE 802.11 standards (i.e., “WiFi”), Bluetooth/Bluetooth Low Energy (BLE), mesh networking protocols such as ZigBee or other wireless networking technologies. Many different types of wireless client devices, such as laptop computers, smartphones, tablets, wearable devices, appliances, and Internet of Things (IoT) devices, incorporate wireless communication technology and can be configured to connect to wireless access points when the device is in range of a compatible wireless access point in order to access a wired network. In the case of a client device running a cloud-based application, such as voice over Internet Protocol (VOIP) applications, streaming video applications, gaming applications, or video conference applications, data is exchanged during an application session from the client device through one or more APs and one or more wired network devices, e.g., switches, routers, and/or gateway devices, to reach the cloud-based application server.

### BRIEF DESCRIPTION OF DRAWINGS

FIG. 1A is a block diagram of an example network system including a network management system, in accordance with one or more techniques of the disclosure.

FIG. 1B is a block diagram illustrating further example details of the network system of FIG. 1A.

FIG. 2 is a block diagram of an example access point device, in accordance with one or more techniques of this disclosure.

FIG. 3 is a block diagram of an example network management system, in accordance with one or more techniques of the disclosure.

FIG. 4 is a block diagram of an example user equipment device, in accordance with one or more techniques of this disclosure.

FIG. 5 is a block diagram of an example network node, such as a router or switch, in accordance with one or more techniques of this disclosure.

FIG. 6 illustrates an example operation performed in accordance with one or more techniques of this disclosure.

### DETAILED DESCRIPTION

In general, this disclosure describes one or more techniques for managing, by a network management system (NMS), radio and/or antenna power of network devices, such as access points (APs), in a network. In some examples, the network comprises a high-density (HD) mesh network or an ultra-high density (UHD) mesh network. For example, each AP in a network of APs collects metrics of utilization and interference, and uploads the metrics to a cloud orchestrator or NMS. The NMS determines an amount of resources to be used by the network, such as a current demand or forecasted demand.

The NMS provides the metrics of utilization and interference for the APs and the amount of resources to be used by the network to an artificial intelligence (AI) model to obtain values of a radio power to be used by each corresponding AP. The NMS may configure at least one of the APs with the corresponding determined value for the radio power. For example, the NMS may increase a power level of a first AP's radio and decrease a power level of a second AP's radio. In some examples, the NMS may configure each AP of the plurality of APs with a value for the radio power determined specifically for the corresponding AP.

It is typically desirable for an access point (AP) to provide as much power to its radios as possible so as to provide the best signal-to-noise ratio, signal strength, and signal coverage to user devices. However, an AP may induce interference in neighboring APs, which may limit the maximum radio power that may practically be used. The problem of interference is more significant in an ultra-high density mesh network of APs, where APs are situated particularly closely to one another, exacerbating the problem of interference. The object of a mesh network power scheme is to maximize AP coverage, minimize the impact to neighboring APs, and smooth roaming of a user device moving across multiple APs.

Solutions that do not use the techniques of the disclosure may allow APs to adjust a radio power based on detected interference. In addition, such solutions that do not use the techniques of the disclosure may allow APs to adjust or turn off a radio during periods of low or no usage. However, such other solutions do not consider the totality of these factors (e.g., AP utilization, interference levels, and network demand) when adjusting power levels. Moreover, such other solutions consider utilization or interference of a particular device, in isolation, when adjusting the power of that specific device. Such other solutions do not consider utilization and interference of multiple devices in the network when adjusting the power of a particular device. Therefore, such other solutions may not provide adequate power management or interference reduction in dense networks, such as high-density (HD) mesh network or an ultra-high density (UHD) mesh networks in which large numbers of APs are broadcasting in close proximity.

In general, this disclosure describes one or more techniques for managing, by a network management system (NMS), radio and/or antenna power of network devices, such as APs, in a network. In some examples, the network comprises an HD mesh network or an UHD mesh network. For example, each AP in a network of APs collects metrics of utilization and interference, and uploads the metrics to a cloud orchestrator or NMS. The NMS provides the metrics of utilization and interference for the APs to an AI model to determine different values of a radio power to be used by each particular AP.

The techniques of the disclosure provide specific improvements to the computer-related field of computer networking that have one or more practical applications. For example, the technical problem to be solved is how to improve network performance and coverage, while reducing adverse impact due to interference by neighboring network devices, especially for HD or UHD mesh networks. For example, the techniques of the disclosure may enable an NMS to perform dynamic adjustment of AP transmit power, which provides a technical solution to this technical problem. For example, by leveraging real-time AP utilization, interference levels, and network demand, the described techniques may enable an NMS to intelligently adjust power levels of APs in a network, even reducing power to zero in high density environments. In addition, the described techniques may leverage the directional antennas of APs to enhance coverage and identify areas where power can be reduced without impacting performance. Unlike systems that do not use the techniques of the disclosure and rely on user-defined power limits, the described techniques may autonomously determine a power range using global minimum and maximum thresholds so as to ensure that deployments maintain efficiency without unnecessary interference. In addition, the techniques of the disclosure may consider the utilization and interference of multiple devices in the network when adjusting the power of a particular device, so as to improve power management and interference reduction in dense networks, such as HD or UHD mesh networks in which large numbers of APs are broadcasting in close proximity, over other solutions not using the techniques described herein. The techniques of the disclosure may enable a network, and particularly an UHD mesh network of APs, to reduce power consumption and interference while satisfying the resource demands of the network, even on a real-time basis.

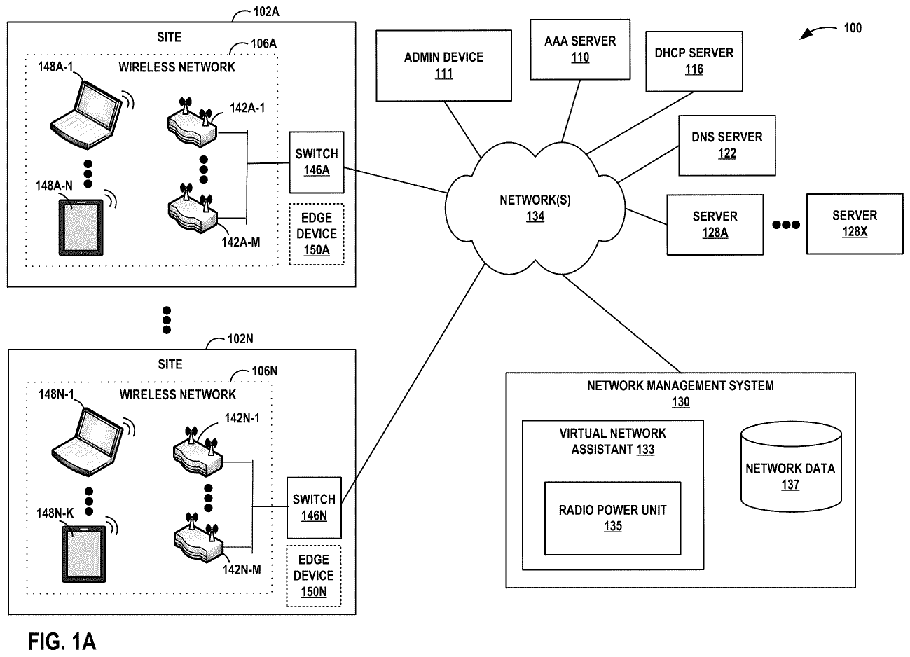

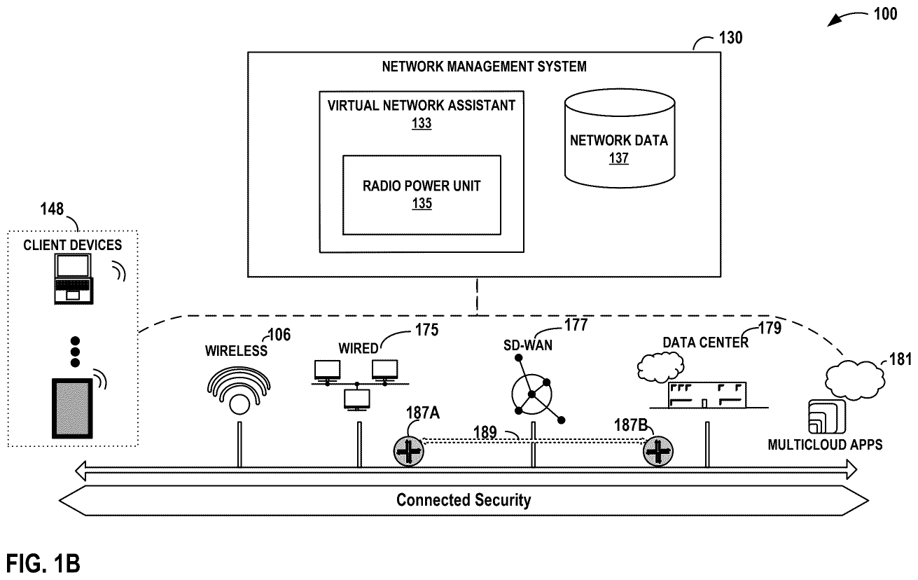

FIG. 1A is a block diagram of an example network system 100 including network management system (NMS) 130, in accordance with one or more techniques of this disclosure. Example network system 100 includes a plurality sites 102A-102N at which a network service provider manages one or more wireless networks 106A-106N, respectively. Although in FIG. 1A each site 102A-102N is shown as including a single wireless network 106A-106N, respectively, in some examples, each site 102A-102N may include multiple wireless networks, and the disclosure is not limited in this respect.

Each site 102A-102N includes a plurality of network access server (NAS) devices, such as access points (APs) 142, switches 146, or routers (not shown). For example, site 102A includes a plurality of APs 142A-1 through 142A-M. Similarly, site 102N includes a plurality of APs 142N-1 through 142N-M. Each AP 142 may be any type of wireless access point, including, but not limited to, a commercial or enterprise AP, a router, or any other device that is connected to a wired network and is capable of providing wireless network access to client devices within the site.

Each site 102A-102N also includes a plurality of client devices, otherwise known as user equipment devices (UEs), referred to generally as UEs or client devices 148, representing various wireless-enabled devices within each site. For example, a plurality of UEs 148A-1 through 148A-K are currently located at site 102A. Similarly, a plurality of UEs 148N-1 through 148N-K are currently located at site 102N. Each UE 148 may be any type of wireless client device, including, but not limited to, a mobile device such as a smart phone, tablet or laptop computer, a personal digital assistant (PDA), a wireless terminal, a smart watch, smart ring, or other wearable device. UEs 148 may also include wired client-side devices, e.g., IoT devices such as printers, security devices, environmental sensors, or any other device connected to the wired network and configured to communicate over one or more wireless networks 106.

In order to provide wireless network services to UEs 148 and/or communicate over the wireless networks 106, APs 142 and the other wired client-side devices at sites 102 are connected, either directly or indirectly, to one or more network devices (e.g., switches, routers, or the like) via physical cables, e.g., Ethernet cables. In the example of FIG. 1A, site 102A includes a switch 146A to which each of APs 142A-1 through 142A-M at site 102A are connected. Similarly, site 102N includes a switch 146N to which each of APs 142N-1 through 142N-M at site 102N are connected. Although illustrated in FIG. 1A as if each site 102 includes a single switch 146 and all APs 142 of the given site 102 are connected to the single switch 146, in other examples, each site 102 may include more or fewer switches and/or routers. In addition, the APs and the other wired client-side devices of the given site may be connected to two or more switches and/or routers. In addition, two or more switches at a site may be connected to each other and/or connected to two or more routers, e.g., via a mesh or partial mesh topology in a hub-and-spoke architecture. In some examples, interconnected switches and routers comprise wired local area networks (LANs) at sites 102 hosting wireless networks 106.

Example network system 100 also includes various networking components for providing networking services within the wired network including, as examples, an Authentication, Authorization and Accounting (AAA) server 110 for authenticating users and/or UEs 148, a Dynamic Host Configuration Protocol (DHCP) server 116 for dynamically assigning network addresses (e.g., IP addresses) to UEs 148 upon authentication, a Domain Name System (DNS) server 122 for resolving domain names into network addresses, a plurality of servers 128A-128X (collectively “servers 128”) (e.g., web servers, databases servers, file servers and the like), and a network management system (NMS) 130. As shown in FIG. 1A, the various devices and systems of network 100 are coupled together via one or more network(s) 134, e.g., the Internet and/or an enterprise intranet.

In the example of FIG. 1A, NMS 130 is a cloud-based computing platform that manages wireless networks 106A-106N at one or more of sites 102A-102N. As further described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. In some examples, NMS 130 outputs notifications, such as alerts, alarms, graphical indicators on dashboards, log messages, text/SMS messages, email messages, and the like, and/or recommendations regarding wireless network issues to a site or network administrator (“admin”) interacting with and/or operating admin device 111. Additionally, in some examples, NMS 130 operates in response to configuration input received from the administrator interacting with and/or operating admin device 111.

The administrator and admin device 111 may comprise IT personnel and an administrator computing device associated with one or more of sites 102. Admin device 111 may be implemented as any suitable device for presenting output and/or accepting user input. For instance, admin device 111 may include a display. Admin device 111 may be a computing system, such as a mobile or non-mobile computing device operated by a user and/or by the administrator. Admin device 111 may, for example, represent a workstation, a laptop or notebook computer, a desktop computer, a tablet computer, or any other computing device that may be operated by a user and/or present a user interface in accordance with one or more aspects of the present disclosure. Admin device 111 may be physically separate from and/or in a different location than NMS 130 such that admin device 111 may communicate with NMS 130 via network 134 or other means of communication.

In some examples, one or more of the NAS devices, e.g., APs 142, switches 146, or routers, may connect to edge devices 150A-150N via physical cables, e.g., Ethernet cables. Edge devices 150 comprise cloud-managed, wireless local area network (LAN) controllers. Each of edge devices 150 may comprise an on-premises device at a site 102 that is in communication with NMS 130 to extend certain microservices from NMS 130 to the on-premises NAS devices while using NMS 130 and its distributed software architecture for scalable and resilient operations, management, troubleshooting, and analytics.

Each one of the network devices of network system 100, e.g., servers 110, 116, 122 and/or 128, APs 142, UEs 148, switches 146, and any other servers or devices attached to or forming part of network system 100, may include a system log or an error log agent wherein each one of these network devices records the status of the network device including normal operational status and error conditions. Throughout this disclosure, one or more of the network devices of network system 100, e.g., servers 110, 116, 122 and/or 128, APs 142, UEs 148, and switches 146, may be considered “third-party” network devices when owned by and/or associated with a different entity than NMS 130 such that NMS 130 does not receive, collect, or otherwise have access to the recorded status and other data of the third-party network devices. In some examples, edge devices 150 may provide a proxy through which the recorded status and other data of the third-party network devices may be reported to NMS 130.

In some examples, NMS 130 monitors network data 137, e.g., one or more service level expectation (SLE) metrics, received from wireless networks 106A-106N at each site 102A-102N, respectively, and manages network resources, such as APs 142 at each site, to deliver a high-quality wireless experience to end users, IoT devices and clients at the site. For example, NMS 130 may include a virtual network assistant (VNA) 133 that implements an event processing platform for providing real-time insights and simplified troubleshooting for IT operations, and that automatically takes corrective action or provides recommendations to proactively address wireless network issues. VNA 133 may, for example, include an event processing platform configured to process hundreds or thousands of concurrent streams of network data 137 from sensors and/or agents associated with APs 142 and/or nodes within network 134. For example, VNA 133 of NMS 130 may include an underlying analytics and network error identification engine and alerting system in accordance with various examples described herein. The underlying analytics engine of VNA 133 may apply historical data and models to the inbound event streams to compute assertions, such as identified anomalies or predicted occurrences of events constituting network error conditions. Further, VNA 133 may provide real-time alerting and reporting to notify a site or network administrator via admin device 111 of any predicted events, anomalies, trends, and may perform root cause analysis and automated or assisted error remediation. In some examples, VNA 133 of NMS 130 may apply AI inferencing techniques to identify the root cause of error conditions detected or predicted from the streams of network data 137. If the root cause may be automatically resolved, VNA 133 may invoke one or more corrective actions to correct the root cause of the error condition, thus automatically improving the underlying SLE metrics and also automatically improving the user experience.

Further example details of operations implemented by the VNA 133 of NMS 130 are described in U.S. Pat. No. 9,832,082, issued Nov. 28, 2017, and entitled “Monitoring Wireless Access Point Events,” U.S. Publication No. US 2021/0306201, published Sep. 30, 2021, and entitled “Network System Fault Resolution Using a Machine Learning Model,” U.S. Pat. No. 10,985,969, issued Apr. 20, 2021, and entitled “Systems and Methods for a Virtual Network Assistant,” U.S. Pat. No. 10,958,585, issued Mar. 23, 2021, and entitled “Methods and Apparatus for Facilitating Fault Detection and/or Predictive Fault Detection,” U.S. Pat. No. 10,958,537, issued Mar. 23, 2021, and entitled “Method for Spatio-Temporal Modeling,” and U.S. Pat. No. 10,862,742, issued Dec. 8, 2020, and entitled “Method for Conveying AP Error Codes Over BLE Advertisements,” all of which are incorporated herein by reference in their entirety.

In operation, NMS 130 observes, collects and/or receives network data 137, which may take the form of data extracted from messages, counters, and statistics, for example. In accordance with one specific implementation, a computing device is part of NMS 130. In accordance with other implementations, NMS 130 may comprise one or more computing devices, dedicated servers, virtual machines, containers, services, or other forms of environments for performing the techniques described herein. Similarly, computational resources and components implementing VNA 133 may be part of the NMS 130, may execute on other servers or execution environments, or may be distributed to nodes within network 134 (e.g., routers, switches, controllers, gateways, and the like).

In accordance with one or more techniques of this disclosure, NMS 130 is configured to perform power management of APs 142 of sites 102. For example, for each of APs 142A of wireless network 106A of site 102A, radio power management unit 135 of VNA 133 of NMS 130 receives a first measurement of utilization of the corresponding one of APs 142A. In addition, for each of APs 142A of wireless network 106A, radio power management unit 135 receives a second measurement of interference associated with the corresponding one of APs 142A.

Radio power management unit 135 determines an amount of resources to be used by wireless network 106A. For example, radio power management unit 135 may determine the amount of resources to be used by wireless network 106A based on various historical usage metrics and/or performance metrics associated with wireless network 106A. Radio power management unit 135 may determine, for example, a number of users or user devices historically active on wireless network 106A at each of a plurality of different time periods (e.g., such as each hour over a previous week or a previous month). As another example, an average amount of bandwidth historically consumed within wireless network 106A during each of the plurality of different time periods. In some examples, radio power management unit 135 may provide such historical usage metrics and/or performance metrics to an AI model to obtain an amount of resources predicted or forecasted to be used by wireless network 106A.

Radio power management unit 135 provides the first measurements of utilization of APs 142A of site 102A, the second measurements of interference associated with APs 142A of site 102A, and the determined amount of resources to be used by wireless network 106A to an AI model to obtain a power level of a radio of at least one of APs 142A of wireless network 106A. In some examples, the AI model determines a power level of a radio of each of APs 142A of wireless network 106A. Radio power management unit 135 configures the at least one of APs 142A with the determined power level.

Although the techniques of the present disclosure are described in this example as performed by NMS 130, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NMS 130, or may be distributed throughout network 100, and may or may not form a part of NMS 130.

FIG. 1B is a block diagram illustrating further example details of the network system of FIG. 1A. In this example, FIG. 1B illustrates NMS 130 configured to operate according to an artificial intelligence/machine-learning-based computing platform providing comprehensive automation, insight, and assurance (WiFi Assurance, Wired Assurance and WAN assurance) spanning from “client,” e.g., user devices 148 connected to wireless network 106 and wired LAN 175 (far left of FIG. 1B), to “cloud,” e.g., cloud-based application services 181 that may be hosted by computing resources within data centers 179 (far right of FIG. 1B).

As described herein, NMS 130 provides an integrated suite of management tools and implements various techniques of this disclosure. In general, NMS 130 may provide a cloud-based platform for wireless network data acquisition, monitoring, activity logging, reporting, predictive analytics, network anomaly identification, and alert generation. For example, network management system 130 may be configured to proactively monitor and adaptively configure network 100 so as to provide self-driving capabilities. Moreover, VNA 133 includes a natural language processing engine to provide AI-driven support and troubleshooting, anomaly detection, AI-driven location services, and AI-driven radio frequency (RF) adjustment with reinforcement learning.

As illustrated in the example of FIG. 1B, AI-driven NMS 130 also provides configuration management, monitoring and automated oversight of software defined wide-area network (SD-WAN) 177, which operates as an intermediate network communicatively coupling wireless networks 106 and wired LANs 175 to data centers 179 and application services 181. In general, SD-WAN 177 provides seamless, secure, traffic-engineered connectivity between “spoke” routers 187A of wired networks 175 hosting wireless networks 106, such as branch or campus networks, to “hub” routers 187B further up the cloud stack toward cloud-based application services 181. SD-WAN 177 often operates and manages an overlay network on an underlying physical Wide-Area Network (WAN), which provides connectivity to geographically separate customer networks. In other words, SD-WAN 177 extends Software-Defined Networking (SDN) capabilities to a WAN and allows network(s) to decouple underlying physical network infrastructure from virtualized network infrastructure and applications such that the networks may be configured and managed in a flexible and scalable manner.

In some examples, underlying routers of SD-WAN 177 may implement a stateful, session-based routing scheme in which the routers 187A, 187B dynamically modify contents of original packet headers sourced by client devices 148 to steer traffic along selected paths, e.g., path 189, toward application services 181 without requiring use of tunnels and/or additional labels. In this way, routers 187A, 187B may be more efficient and scalable for large networks since the use of tunnel-less, session-based routing may enable routers 187A, 187B to achieve considerable network resources by obviating the need to perform encapsulation and decapsulation at tunnel endpoints. Moreover, in some examples, each router 187A, 187B may independently perform path selection and traffic engineering to control packet flows associated with each session without requiring use of a centralized SDN controller for path selection and label distribution. In some examples, routers 187A, 187B implement session-based routing as Secure Vector Routing (SVR), provided by Juniper Networks, Inc.

Additional information with respect to session-based routing and SVR is described in U.S. Pat. No. 9,729,439, entitled “COMPUTER NETWORK PACKET FLOW CONTROLLER,” and issued on Aug. 8, 2017; U.S. Pat. No. 9,729,682, entitled “NETWORK DEVICE AND METHOD FOR PROCESSING A SESSION USING A PACKET SIGNATURE,” and issued on Aug. 8, 2017; U.S. Pat. No. 9,762,485, entitled “NETWORK PACKET FLOW CONTROLLER WITH EXTENDED SESSION MANAGEMENT,” and issued on Sep. 12, 2017; U.S. Pat. No. 9,871,748, entitled “ROUTER WITH OPTIMIZED STATISTICAL FUNCTIONALITY,” and issued on Jan. 16, 2018; U.S. Pat. No. 9,985,883, entitled “NAME-BASED ROUTING SYSTEM AND METHOD,” and issued on May 29, 2018; U.S. Pat. No. 10,200,264, entitled “LINK STATUS MONITORING BASED ON PACKET LOSS DETECTION,” and issued on Feb. 5, 2019; U.S. Pat. No. 10,277,506, entitled “STATEFUL LOAD BALANCING IN A STATELESS NETWORK,” and issued on Apr. 30, 2019; U.S. Pat. No. 10,432,522, entitled “NETWORK PACKET FLOW CONTROLLER WITH EXTENDED SESSION MANAGEMENT,” and issued on Oct. 1, 2019; and U.S. Pat. No. 11,075,824, entitled “IN-LINE PERFORMANCE MONITORING,” and issued on Jul. 27, 2021, the entire content of each of which is incorporated herein by reference in its entirety.

In some examples, AI-driven NMS 130 may enable intent-based configuration and management of network system 100, including enabling construction, presentation, and execution of intent-driven workflows for configuring and managing devices associated with wireless networks 106, wired LAN networks 175, and/or SD-WAN 177. For example, declarative requirements express a desired configuration of network components without specifying an exact native device configuration and control flow. By utilizing declarative requirements, what should be accomplished may be specified rather than how it should be accomplished. Declarative requirements may be contrasted with imperative instructions that describe the exact device configuration syntax and control flow to achieve the configuration. By utilizing declarative requirements rather than imperative instructions, a user and/or user system is relieved of the burden of determining the exact device configurations that may achieve a desired result of the user/system. For example, it is often difficult and burdensome to specify and manage exact imperative instructions to configure each device of a network when various different types of devices from different vendors are utilized. The types and kinds of devices of the network may dynamically change as new devices are added and device failures occur. Managing various different types of devices from different vendors with different configuration protocols, syntax, and software versions to configure a cohesive network of devices is often difficult to achieve. Thus, by enabling a user/system to specify declarative requirements that specify a desired result applicable across various different types of devices, management and configuration of the network devices becomes more efficient. Further example details and techniques of an intent-based network management system are described in U.S. Pat. No. 10,756,983, entitled “Intent-based Analytics,” and U.S. Pat. No. 10,992,543, entitled “Automatically generating an intent-based network model of an existing computer network,” each of which is hereby incorporated by reference.

In accordance with one or more techniques of this disclosure, NMS 130 is configured to perform power management of APs 142 of sites 102. For example, for each of APs 142A of wireless network 106A of site 102A, radio power management unit 135 of VNA 133 of NMS 130 receives a first measurement of utilization of the corresponding one of APs 142A. In addition, for each of APs 142A of wireless network 106A, radio power management unit 135 receives a second measurement of interference associated with the corresponding one of APs 142A. Based at least in part on the first measurements of utilization and the second measurements of interference of APs 142A of site 102A, radio power management unit 135 determines an amount of resources to be used by wireless network 106A.

Radio power management unit 135 provides the first measurements of utilization of APs 142A of site 102A, the second measurements of interference associated with APs 142A of site 102A, and the determined amount of resources to be used by wireless network 106A to an AI model to determine a power level of a radio of at least one AP 142A of wireless network 106A. In some examples, the AI model determines a power level of a radio of each of APs 142A of wireless network 106A. Radio power management unit 135 configures the at least one of APs 142A with the determined power level.

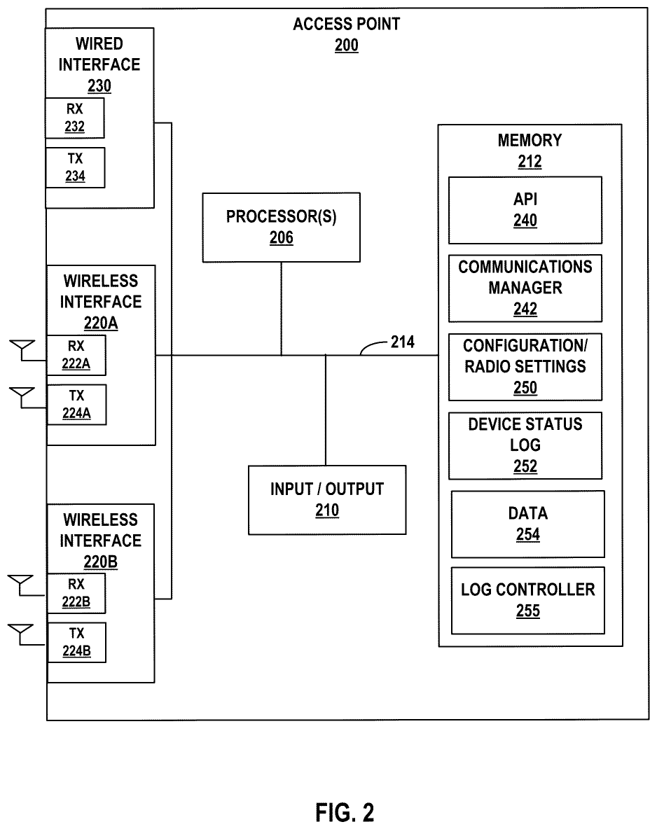

FIG. 2 is a block diagram of an example access point (AP) device 200, in accordance with one or more techniques of this disclosure. Example access point 200 shown in FIG. 2 may be used to implement any of APs 142 as shown and described herein with respect to FIG. 1A. Access point 200 may comprise, for example, a Wi-Fi, Bluetooth and/or Bluetooth Low Energy (BLE) base station or any other type of wireless access point.

In the example of FIG. 2, access point 200 includes a wired interface 230, wireless interfaces 220A-220B one or more processor(s) 206, memory 212, and input/output 210, coupled together via a bus 214 over which the various elements may exchange data and information. Wired interface 230 represents a physical network interface and includes a receiver 232 and a transmitter 234 for sending and receiving network communications, e.g., packets. Wired interface 230 couples, either directly or indirectly, access point 200 to a wired network device, such as one of switches 146 of FIG. 1A, within the wired network via a cable, such as an Ethernet cable.

First and second wireless interfaces 220A and 220B represent wireless network interfaces and include receivers 222A and 222B, respectively, each including a receive antenna via which access point 200 may receive wireless signals from wireless communications devices, such as UEs 148 of FIG. 1A. First and second wireless interfaces 220A and 220B further include transmitters 224A and 224B, respectively, each including transmit antennas via which access point 200 may transmit wireless signals to wireless communications devices, such as UEs 148 of FIG. 1A. In some examples, first wireless interface 220A may include a Wi-Fi 802.11 interface (e.g., 2.4 GHz and/or 5 GHZ) and second wireless interface 220B may include a Bluetooth interface and/or a Bluetooth Low Energy (BLE) interface.

Processor(s) 206 are programmable hardware-based processors configured to execute software instructions, such as those used to define a software or computer program, stored to a computer-readable storage medium (such as memory 212), such as non-transitory computer-readable mediums including a storage device (e.g., a disk drive, or an optical drive) or a memory (such as Flash memory or RAM) or any other type of volatile or non-volatile memory, that stores instructions to cause the one or more processors 206 to perform the techniques described herein.

Memory 212 includes one or more devices configured to store programming applications and/or data associated with operation of access point 200. For example, memory 212 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 206 to perform the techniques described herein.

In this example, memory 212 stores executable software including an application programming interface (API) 240, a communications manager 242, configuration settings 250, a device status log 252, data storage 254, and log controller 255. Device status log 252 includes a list of events specific to access point 200. The events may include a log of both normal events and error events such as, for example, memory status, reboot or restart events, crash events, cloud disconnect with self-recovery events, low link speed or link speed flapping events, Ethernet port status, Ethernet interface packet errors, upgrade failure events, firmware upgrade events, configuration changes, etc., as well as a time and date stamp for each event. Log controller 255 determines a logging level for the device based on instructions from NMS 130. Data 254 may store any data used and/or generated by access point 200, including data collected from UEs 148, such as data used to calculate one or more SLE metrics, that is transmitted by access point 200 for cloud-based management of wireless networks 106A by NMS 130.

Input/output (I/O) 210 represents physical hardware components that enable interaction with a user, such as buttons, a display, and the like. Although not shown, memory 212 typically stores executable software for controlling a user interface with respect to input received via I/O 210. Communications manager 242 includes program code that, when executed by processor(s) 206, allow access point 200 to communicate with UEs 148 and/or network(s) 134 via any of interface(s) 230 and/or 220A-220C. Configuration settings 250 include any device settings for access point 200 such as radio settings for each of wireless interface(s) 220A-220C. These settings may be configured manually or may be remotely monitored and managed by NMS 130 to adjust wireless network performance on a periodic (e.g., hourly or daily) basis.

As described herein, AP device 200 may measure and report network data from status log 252 to NMS 130. The network data may comprise event data, telemetry data, and/or other SLE-related data. The network data may include various parameters indicative of the performance and/or status of the wireless network. The parameters may be measured and/or determined by one or more of the UE devices and/or by one or more of the APs in a wireless network. NMS 130 may determine one or more SLE metrics based on the SLE-related data received from the APs in the wireless network and store the SLE metrics as network data 137 (FIG. 1A).

In accordance with the techniques of the disclosure, AP 200 collects metrics regarding utilization and interference of AP 200. For example, AP 200 collects metrics related to utilization including, e.g., power levels of receivers 222 and transmitters 224 of wireless interfaces 220, network bandwidth consumed by receivers 222 and transmitters 224 of wireless interfaces 220, etc. As another example, AP 200 collects metrics related to interference, including, e.g., interference received by wireless interfaces 220. Communications manager 242 of AP 200 uploads such metrics to NMS 130.

In some examples, AP 200 receives an adjustment to configuration/radio settings 250 of AP 200. In some examples, the adjustment comprises an adjustment to a power level of one of transmitters 224A of wireless interface 220A, or a radio of transmitters 224A (not depicted in FIG. 2). In some examples, the adjustment comprises an adjustment to a schedule during which transmitters 224A (or other components of wireless interface 220A) are activated or deactivated. In some examples, the adjustment includes deactivating transmitters 224A (or other components of wireless interface 220A) for a specified amount of time.

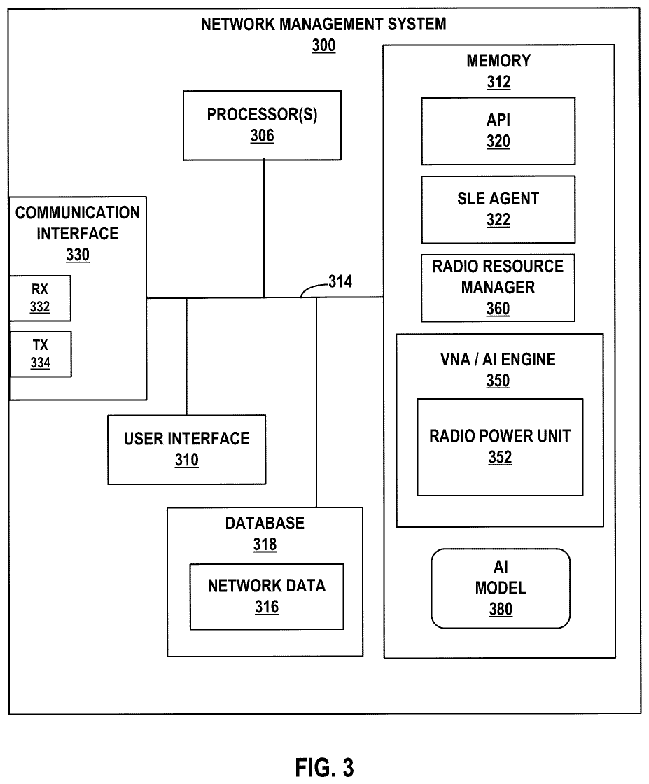

FIG. 3 is a block diagram of an example network management system (NMS) 300, in accordance with one or more techniques of the disclosure. NMS 300 may be used to implement, for example, NMS 130 in FIGS. 1A-1B. In such examples, NMS 300 is responsible for monitoring and management of one or more wireless networks 106A-106N at sites 102A-102N, respectively.

NMS 300 includes a communications interface 330, one or more processor(s) 306, a user interface 310, a memory 312, and a database 318. The various elements are coupled together via a bus 314 over which the various elements may exchange data and information. In some examples, NMS 300 receives data from one or more of client devices 148, APs 142, switches 146 and other network nodes within network 134, e.g., routers 187 of FIG. 1B, which may be used to calculate one or more SLE metrics and/or update network data 316 in database 318. NMS 300 analyzes this data for cloud-based management of wireless networks 106A-106N. In some examples, NMS 300 may be part of another server shown in FIG. 1A or a part of any other server.

Processor(s) 306 execute software instructions, such as those used to define a software or computer program, stored to a computer-readable storage medium (such as memory 312), such as non-transitory computer-readable mediums including a storage device (e.g., a disk drive, or an optical drive) or a memory (such as Flash memory or RAM) or any other type of volatile or non-volatile memory, that stores instructions to cause the one or more processors 306 to perform the techniques described herein.

Communications interface 330 may include, for example, an Ethernet interface. Communications interface 330 couples NMS 300 to a network and/or the Internet, such as any of network(s) 134 as shown in FIG. 1A, and/or any local area networks. Communications interface 330 includes a receiver 332 and a transmitter 334 by which NMS 300 receives/transmits data and information to/from any of client devices 148, APs 142, switches 146, servers 110, 116, 122, 128 and/or any other network nodes, devices, or systems forming part of network system 100 such as shown in FIG. 1A. In some scenarios described herein in which network system 100 includes “third-party” network devices that are owned and/or associated with different entities than NMS 300, NMS 300 does not receive, collect, or otherwise have access to network data from the third-party network devices.

The data and information received by NMS 300 may include, for example, telemetry data, SLE-related data, or event data received from one or more of client device APs 148, APs 142, switches 146, or other network nodes, e.g., routers 187 of FIG. 1B, used by NMS 300 to remotely monitor the performance of wireless networks 106A-106N and application sessions from client device to cloud-based application server. NMS 300 may further transmit data via communications interface 330 to any of network devices such as client devices 148, APs 142, switches 146, other network nodes within network 134, admin device 111 to remotely manage wireless networks 106A-106N and portions of the wired network.

Memory 312 includes one or more devices configured to store programming applications and/or data associated with operation of NMS 300. For example, memory 312 may include a computer-readable storage medium, such as a non-transitory computer-readable medium including a storage device (e.g., a disk drive, or an optical drive) or a memory (such as Flash memory or RAM) or any other type of volatile or non-volatile memory, that stores instructions to cause the one or more processor(s) 306 to perform the techniques described herein.

In this example, memory 312 includes an API 320, an SLE agent 322, a virtual network assistant (VNA)/AI engine 350, and a radio resource management (RRM) engine 360. In accordance with the disclosed techniques, VNA/AI engine 350 includes radio power unit 352. NMS 300 may also include any other programmed applications, software engines and/or interfaces configured for remote monitoring and management of wireless networks 106A-106N and portions of the wired network, including remote monitoring and management of any of APs 142/200, switches 146, or other network devices, e.g., routers 187 of FIG. 1B.

SLE agent 322 enables set up and tracking of thresholds for SLE metrics for each network 106A-106N. SLE agent 322 further analyzes SLE-related data collected by APs, such as any of APs 142 from UEs in each wireless network 106A-106N. For example, APs 142A-1 through 142A-N collect SLE-related data from UEs 148A-1 through 148A-N currently connected to wireless network 106A. This data is transmitted to NMS 300, which executes by SLE agent 322 to determine one or more SLE metrics for each UE 148A-1 through 148A-N currently connected to wireless network 106A. This data, in addition to any network data collected by one or more APs 142A-1 through 142A-N in wireless network 106A, is transmitted to NMS 300 and stored as, for example, network data 316 in database 318.

RRM engine 360 monitors one or more metrics for each site 102A-102N in order to learn and adjust the RF environment at each site. For example, RRM engine 360 may monitor the coverage and capacity SLE metrics for a wireless network 106 at a site 102 in order to identify potential issues with SLE coverage and/or capacity in the wireless network 106 and to make adjustments to the radio settings of the access points at each site to address the identified issues. For example, RRM engine may determine channel and transmit power distribution across all APs 142 in each network 106A-106N. For example, RRM engine 360 may monitor events, power, channel, bandwidth, and number of clients connected to each AP. RRM engine 360 may further automatically change or update configurations of one or more APs 142 at a site 102 with an aim to improve the coverage and capacity SLE metrics and thus to provide an improved wireless experience for the user.

VNA/AI engine 350 analyzes data received from network devices as well as its own data to identify when undesired to abnormal states are encountered at one of the network devices. For example, VNA/AI engine 350 may identify the root cause of any undesired or abnormal states, e.g., any poor SLE metric(s) indicative of connected issues at one or more network devices. In addition, VNA/AI engine 350 may automatically invoke one or more corrective actions intended to address the identified root cause(s) of one or more poor SLE metrics. Examples of corrective actions that may be automatically invoked by VNA/AI engine 350 may include, but are not limited to, invoking RRM 360 to reboot one or more APs, adjusting/modifying the transmit power of a specific radio in a specific AP, adding SSID configuration to a specific AP, changing channels on an AP or a set of APs, etc. The corrective actions may further include restarting a switch and/or a router, invoking downloading of new software to an AP, switch, or router, etc. These corrective actions are given as example purposes, and the disclosure is not limited in this respect. If automatic corrective actions are not available or do not adequately resolve the root cause, VNA/AI engine 350 may proactively provide a notification including recommended corrective actions to be taken by IT personnel, e.g., a site or network administrator using admin device 111, to address the network error.

In accordance with one or more techniques of this disclosure, NMS 130 is configured to perform power management of APs 142 of sites 102. For example, for each of APs 142A of wireless network 106A of site 102A of FIG. 1A, radio power management unit 352 of VNA 350 receives a first measurement of utilization of the corresponding one of APs 142A. In some examples, the measurement of utilization may include one or more of:

util_tx. This measurement refers to an airtime that an AP uses to transmit data to one or more clients associated with the AP. For example, if an AP has 10 clients and is sending data to the 10 clients, this activity contributes to the util_tx measurement.

util_rx_in_bss. This measurement refers to an airtime that an AP spends receiving data from one or more clients associated with the AP. In the same example, if an AP has 10 clients, and those 10 clients are uploading data or sending requests, the airtime used for the reception of such data or requests is counted as util_rx_in_bss.

util_rx_other_bss. This measurement represents an airtime used by other APs and their clients operating on a same channel as an AP under consideration, and indicates co-channel interference. For example, if a first AP has 10 first clients, and a second AP has 15 second clients on a same channel as the first AP, the transmissions between the second AP and the 15 second clients are measured as part of the first AP's value for util_rx_other_bss.

util_unknown_wifi. This measurement accounts for airtime taken by other transmissions, such as Wi-Fi transmissions, and an AP does not recognize as belonging to its BSS or any of the AP's known neighbors. These transmissions may originate from unknown hotspots, transient clients, or rogue devices briefly appearing in the area, and may be a source of interference to the AP.

util_undecodable. This measurement is an amount of airtime that measures transmissions or messages received from another AP that are undecodable. This may occur due to scrambling or corruption of the message due to signal noise and interference. This measurement may be, e.g., a count of undecodable messages received by the AP.

util_non_wifi. This measurement measures an airtime consumed by non-Wi-Fi sources of interference, such as Bluetooth devices, microwaves, or other electronics operating in the same frequency band, which an AP can detect but not able to decode as a valid Wi-Fi message.

In addition, for each of APs 142A of wireless network 106A, radio power management unit 352 receives a second measurement of interference associated with the corresponding one of APs 142A. The second measurement of interference may indicate, e.g., an interference received by the one of APs 142A or an interference caused or induced by the one of APs 142A. In some examples, the second measurement of interference may be measured in, e.g., decibels.

In some examples, for each of APs 142A of wireless network 106A, radio power management unit 352 further receives information on radio, transmitter, or antenna power of the corresponding one of APs 142. Such information may include, e.g., power strength, active or inactive times or schedules, a number of RF chains, a power state or level of the radio or RF chains, etc.

Based at least in part on the first measurements of utilization and the second measurements of interference of APs 142A of site 102A, radio power management unit 352 determines an amount of resources to be used by wireless network 106A. For example, radio power management unit 352 may determine that a given network utilization of wireless network 106A may use a particular amount of allocated resources of APs 142A to overcome interference measured within wireless network 106A.

Radio power management unit 135 applies AI model 380 to the first measurements of utilization of APs 142A of site 102A, the second measurements of interference associated with APs 142A of site 102A, and the determined amount of resources to be used by wireless network 106A to determine a power level of a radio of at least one of APs 142A of wireless network 106A. In some examples, AI model 380 determines an adjustment to a configuration of a radio of each of APs 142A, such as an adjustment to a power level of a radio of each of APs 142A of wireless network 106A. In some examples, the determined adjustment comprises at least one of a maximum power level, a minimum power level, or a combination thereof, of one or more radios of each of APs 142A. Radio power management unit 135 causes radio resource manager 360 to perform the adjustment to the configuration of the radio of the at least one of APs 142A.

In some examples, AI model 380 may comprise a supervised machine learning model that is trained, using training data comprising pre-collected, labeled network data received from network devices (e.g., client devices, APs, switches and/or other network nodes), to determine a power level of a radio or antenna of a network device, while maximizing utilization rates, minimizing power consumption, and minimizing interference caused to neighboring network devices. The supervised machine learning model may comprise one of a logistical regression, naïve Bayesian, support vector machine (SVM), or the like. In other examples, AI model 380 may comprise an unsupervised machine learning model. Although not shown in FIG. 3, in some examples, database 318 may store the training data and VNA/AI engine 350 or a dedicated training agent may be configured to train AI model 380 based on the training data to determine appropriate weights across the one or more features of the training data. In some examples, AI model 380 may comprise a large language model (LLM), a small language model (SLM), a long short-term memory (LSTM) model, or another type of generative AI model, machine learning model, deep learning model, or neural network. In some examples, AI model 380 may be provided by a third party, such as a cloud service provider, and distributed across one or more servers of a distributed network, such as a cloud computing network.

In an example implementation, wireless network 106A of site 102A (FIG. 1A) is an UHD mesh network of APs 142A. Each of APs 142A collects metrics of utilization and signal interference, and uploads the metrics to a centralized orchestrator, such as radio power unit 352 of VNA 350 of NMS 300. Radio power unit 352 determines that a “util_undecodable” metric for, e.g., AP 142A-1 exceeds a predetermined threshold. “Util_undecodable” is a novel metric for utilization of an AP. Specifically, the “util_undecodable” metric indicates that a header or content of a signal, received by e.g., AP 142A-1 from AP 142A-N, is undecodable. This may occur when a radio power of AP 142A-1 is so strong that it is causing interference in a signal received from another AP, such as AP 142A-N, causing distortion, corruption, or scrambling the signal. The occurrence of the undecodable signal may be used as a basis upon which to lower the radio power of the first AP. For example, based at least in part on the “util_undecodable” metric for AP 142A-1 exceeding the predetermined threshold, radio power unit 352 causes radio resource manager 360 to configure AP 142A-1 to reduce a radio power of AP 142A-1.

In another example implementation, wireless network 106A of site 102A (FIG. 1A) is an UHD mesh network of APs 142A. Each of APs 142A collects metrics of utilization and signal interference, and uploads the metrics to a centralized orchestrator, such as radio power unit 352 of VNA 350 of NMS 300. Radio power unit 352 applies AI model 380 to determine, for each of APs 142A and based on the metrics of utilization and signal interference of each of the plurality of APs 142A, a value for a radio power of the corresponding one of APs 142A. Radio power unit 352 causes radio resource manager 360 to configure each of APs 142A with the corresponding determined value of the radio power to maximize signal coverage, mitigate interference, and adjust power consumption. In some examples, radio resource manager 360 configures each of APs 142A with a same value for the radio power. In some examples, radio resource manager 360 configures each of APs 142A with a different value for the radio power. Therefore, radio resource manager 360, using the techniques described herein, may determine a maximum transmit power of a radio of each of APs 142A of wireless network 106A based at least in part on: (1) the utilization of each of APs 142A, (2) levels of interference levels experienced by each of APs 142A, and (3) the overall network demand of the network. In some examples, radio resource manager 360, using the techniques described herein, may also determine a minimum transmit power of a radio of each of APs 142A of wireless network 106A based at least in part on: (1) the utilization of each of APs 142A, (2) levels of interference levels experienced by each of APs 142A, and (3) the overall network demand of the network.

Although the techniques of the present disclosure are described in this example as performed by NMS 130, techniques described herein may be performed by any other computing device(s), system(s), and/or server(s), and that the disclosure is not limited in this respect. For example, one or more computing device(s) configured to execute the functionality of the techniques of this disclosure may reside in a dedicated server or be included in any other server in addition to or other than NMS 130, or may be distributed throughout network 100, and may or may not form a part of NMS 130.

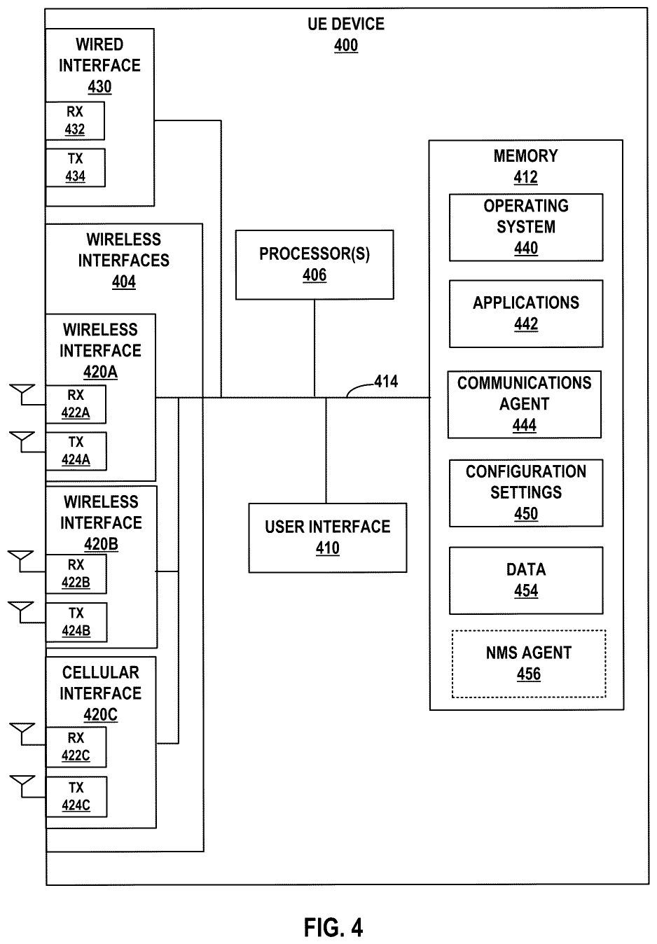

FIG. 4 shows an example user equipment (UE) device 400, in accordance with one or more techniques of this disclosure. Example UE device 400 shown in FIG. 4 may be used to implement any of UEs 148 as shown and described herein with respect to FIG. 1A. UE device 400 may include any type of wireless client device, and the disclosure is not limited in this respect. For example, UE device 400 may include a mobile device such as a smart phone, tablet or laptop computer, a personal digital assistant (PDA), a wireless terminal, a smart watch, a smart ring, or any other type of mobile or wearable device. In some examples, UE 400 may also include a wired client-side device, e.g., an IoT device such as a printer, a security sensor or device, an environmental sensor, or any other device connected to the wired network and configured to communicate over one or more wireless networks.

UE device 400 includes a wired interface 430, wireless interfaces 420A-420C, one or more processor(s) 406, memory 412, and a user interface 410. The various elements are coupled together via a bus 414 over which the various elements may exchange data and information. Wired interface 430 represents a physical network interface and includes a receiver 432 and a transmitter 434. Wired interface 430 may be used, if desired, to couple, either directly or indirectly, UE 400 to a wired network device, such as one of switches 146 of FIG. 1A, within the wired network via a cable, such as one of Ethernet cables 144 of FIG. 1A.

First, second and third wireless interfaces 420A, 420B, and 420C include receivers 422A, 422B, and 422C, respectively, each including a receive antenna via which UE 400 may receive wireless signals from wireless communications devices, such as APs 142 of FIG. 1A, AP 200 of FIG. 2, other UEs 148, or other devices configured for wireless communication. First, second, and third wireless interfaces 420A, 420B, and 420C further include transmitters 424A, 424B, and 424C, respectively, each including transmit antennas via which UE 400 may transmit wireless signals to wireless communications devices, such as APs 142 of FIG. 1A, AP 200 of FIG. 2, other UEs 148 and/or other devices configured for wireless communication. In some examples, first wireless interface 420A may include a Wi-Fi 802.11 interface (e.g., 2.4 GHz and/or 5 GHZ) and second wireless interface 420B may include a Bluetooth interface and/or a Bluetooth Low Energy interface. Third wireless interface 420C may include, for example, a cellular interface through which UE device 400 may connect to a cellular network.

Processor(s) 406 execute software instructions, such as those used to define a software or computer program, stored to a computer-readable storage medium (such as memory 412), such as non-transitory computer-readable mediums including a storage device (e.g., a disk drive, or an optical drive) or a memory (such as Flash memory or RAM) or any other type of volatile or non-volatile memory, that stores instructions to cause the one or more processors 406 to perform the techniques described herein.

Memory 412 includes one or more devices configured to store programming applications and/or data associated with operation of UE 400. For example, memory 412 may include a computer-readable storage medium, such as non-transitory computer-readable mediums including a storage device (e.g., a disk drive, or an optical drive) or a memory (such as Flash memory or RAM) or any other type of volatile or non-volatile memory, that stores instructions to cause the one or more processor(s) 406 to perform the techniques described herein.

In this example, memory 412 includes an operating system 440, applications 442, a communications agent 444, configuration settings 450, and data storage 454. Communications agent 444 includes program code that, when executed by processor(s) 406, enables UE 400 to communicate using any of wired interface(s) 430, wireless interfaces 420A-420B and/or cellular interface 450C. Configuration settings 450 include any device settings for UE 400 settings for each of wireless interface(s) 420A-420B and/or cellular interface 420C.

Data storage 454 may include, for example, a status/error log including a list of events specific to UE 400. The events may include a log of both normal events and error events according to a logging level based on instructions from NMS 130. Data storage 454 may store any data used and/or generated by UE 400, such as data used to calculate one or more SLE metrics or identify relevant behavior data, that is collected by UE 400 and either transmitted directly to NMS 130 or transmitted to any of APs 142 in a wireless network 106 for further transmission to NMS 130.

As described herein, UE 400 may measure and report network data from data storage 454 to NMS 130. The network data may comprise event data, telemetry data, and/or other SLE-related data. The network data may include various parameters indicative of the performance and/or status of the wireless network. NMS 130 may determine one or more SLE metrics and store the SLE metrics as network data 137 (FIG. 1A) based on the SLE-related data received from the UEs or client devices in the wireless network.

Optionally, UE device 400 may include an NMS agent 456. NMS agent 456 is a software agent of NMS 130 that is installed on UE 400. In some examples, NMS agent 456 can be implemented as a software application running on UE 400. NMS agent 456 collects information including detailed client-device properties from UE 400, including insight into UE 400 roaming behaviors. The information provides insight into client roaming algorithms, because roaming is a client device decision. In some examples, NMS agent 456 may display the client-device properties on UE 400. NMS agent 456 sends the client device properties to NMS 130, via an AP device to which UE 400 is connected. NMS agent 456 can be integrated into a custom application or as part of location application. NMS agent 456 may be configured to recognize device connection types (e.g., cellular or Wi-Fi), along with the corresponding signal strength. For example, NMS agent 456 recognizes access point connections and their corresponding signal strengths. NMS agent 456 can store information specifying the APs recognized by UE 400 as well as their corresponding signal strengths. NMS agent 456 or other element of UE 400 also collects information about which APs the UE 400 connected with, which also indicates which APs the UE 400 did not connect with. NMS agent 456 of UE 400 sends this information to NMS 130 via its connected AP. In this manner, UE 400 sends information about not just the AP that UE 400 connected with, but also information about other APs that UE 400 recognized and did not connect with, and their signal strengths. The AP in turn forwards this information to the NMS, including the information about other APs the UE 400 recognized besides itself. This additional level of granularity enables NMS 130, and ultimately network administrators, to better determine the Wi-Fi experience directly from the client device's perspective.

In some examples, NMS agent 456 further enriches the client device data leveraged in service levels. For example, NMS agent 456 may go beyond basic fingerprinting to provide supplemental details into properties such as device type, manufacturer, and different versions of operating systems. In the detailed client properties, the NMS 130 can display the Radio Hardware and Firmware information of UE 400 received from NMS client agent 456. The more details the NMS agent 456 can draw out, the better the VNA/AI engine gets at advanced device classification. The VNA/AI engine of the NMS 130 continually learns and becomes more accurate in its ability to distinguish between device-specific issues or broad device issues, such as specifically identifying that a particular OS version is affecting certain clients.

In some examples, NMS agent 456 may cause user interface 410 to display a prompt that prompts an end user of UE 400 to enable location permissions before NMS agent 456 is able to report the device's location, client information, and network connection data to the NMS. NMS agent 456 will then start reporting connection data to the NMS along with location data. In this manner, the end user of the client device can control whether the NMS agent 456 is enabled to report client device information to the NMS.

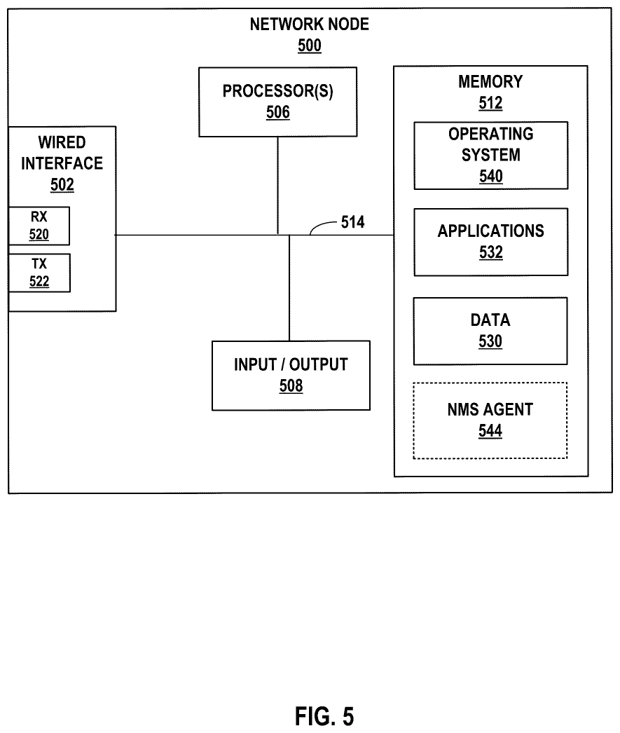

FIG. 5 is a block diagram illustrating an example network node 500, in accordance with one or more techniques of this disclosure. In one or more examples, the network node 500 implements a device or a server attached to the network 134 of FIG. 1A, e.g., switches 146, AAA server 110, DHCP server 116, DNS server 122, web servers 128, etc., or another network device supporting one or more of wireless network 106, wired LAN 175, or SD-WAN 177, or data center 179 of FIG. 1B, e.g., routers 187.

In this example, network node 500 includes a wired interface 502, e.g., an Ethernet interface, a processor 506, input/output 508, e.g., display, buttons, keyboard, keypad, touch screen, mouse, etc., and a memory 512 coupled together via a bus 514 over which the various elements may interchange data and information. Wired interface 502 couples the network node 500 to a network, such as an enterprise network. Though one interface is shown by way of example, network nodes may, and usually do, have multiple communication interfaces and/or multiple communication interface ports. Wired interface 502 includes a receiver 520 and a transmitter 522.

Memory 512 stores executable software applications 532, operating system 540 and data/information 530. Data 530 may include a system log and/or an error log that stores event data, including behavior data, for network node 500. In examples where network node 500 comprises a “third-party” network device, the same entity does not own or have access to both the APs or wired client-side devices and network node 500. As such, in the example where network node 500 is a third-party network device, NMS 130 does not receive, collect, or otherwise have access to the network data from network node 500.

In examples where network node 500 comprises a server, network node 500 may receive data and information, e.g., including operation related information, e.g., registration request, AAA services, DHCP requests, Simple Notification Service (SNS) look-ups, and Web page requests via receiver 520, and send data and information, e.g., including configuration information, authentication information, web page data, etc. via transmitter 522.

In examples where network node 500 comprises a wired network device, network node 500 may be connected via wired interface 502 to one or more APs or other wired client-side devices, e.g., IoT devices. For example, network node 500 may include multiple wired interfaces 502 and/or wired interface 502 may include multiple physical ports to connect to multiple APs or the other wired-client-side devices within a site via respective Ethernet cables. In some examples, each of the APs or other wired client-side devices connected to network node 500 may access the wired network via wired interface 502 of network node 500. In some examples, one or more of the APs or other wired client-side devices connected to network node 500 may each draw power from network node 500 via the respective Ethernet cable and a Power over Ethernet (POE) port of wired interface 502.

In examples where network node 500 comprises a session-based router that employs a stateful, session-based routing scheme, network node 500 may be configured to independently perform path selection and traffic engineering. The use of session-based routing may enable network node 500 to eschew the use of a centralized controller, such as an SDN controller, to perform path selection and traffic engineering, and eschew the use of tunnels. In some examples, network node 500 may implement session-based routing as Secure Vector Routing (SVR), provided by Juniper Networks, Inc. In the case where network node 500 comprises a session-based router operating as a network gateway for a site of an enterprise network (e.g., router 187A of FIG. 1B), network node 500 may establish multiple peer paths (e.g., logical path 189 of FIG. 1B) over an underlying physical WAN (e.g., SD-WAN 177 of FIG. 1B) with one or more other session-based routers operating as network gateways for other sites of the enterprise network (e.g., router 187B of FIG. 1B). Network node 500, operating as a session-based router, may collect data at a peer path level, and report the peer path data to NMS 130.

In examples where network node 500 comprises a packet-based router, network node 500 may employ a packet- or flow-based routing scheme to forward packets according to defined network paths, e.g., established by a centralized controller that performs path selection and traffic engineering. In the case where network node 500 comprises a packet-based router operating as a network gateway for a site of an enterprise network (e.g., router 187A of FIG. 1B), network node 500 may establish multiple tunnels (e.g., logical path 189 of FIG. 1B) over an underlying physical WAN (e.g., SD-WAN 177 of FIG. 1B) with one or more other packet-based routers operating as network gateways for other sites of the enterprise network (e.g., router 187B of FIG. 1B). Network node 500, operating as a packet-based router, may collect data at a tunnel level, and the tunnel data may be retrieved by NMS 130 via an API or an open configuration protocol or the tunnel data may be reported to NMS 130 by NMS agent 544 or other application running on network node 500.

The data collected and reported by network node 500 may include periodically-reported data and event-driven data. Network node 500 is configured to collect logical path statistics via bidirectional forwarding detection (BFD) probing and data extracted from messages and/or counters at the logical path (e.g., peer path or tunnel) level. In some examples, network node 500 is configured to collect statistics and/or sample other data according to a first periodic interval, e.g., each 3 seconds, each 5 seconds, etc. Network node 500 may store the collected and sampled data as path data, e.g., in a buffer.

In some examples, network node 500 optionally includes an NMS agent 544. NMS agent 544 may periodically create a package of the statistical data according to a second periodic interval, e.g., each 3 minutes. The collected and sampled data periodically-reported in the package of statistical data may be referred to herein as “oc-stats.” In some examples, the package of statistical data may also include details about clients connected to network node 500 and the associated client sessions. NMS agent 544 may then report the package of statistical data to NMS 130 in the cloud. In other examples, NMS 130 may request, retrieve, or otherwise receive the package of statistical data from network node 500 via an API, an open configuration protocol, or another of communication protocols. The package of statistical data created by NMS agent 544 or another application of network node 500 may include a header identifying network node 500 and the statistics and data samples for each of the logical paths from network node 500. In still other examples, NMS agent 544 reports event data to NMS 130 in the cloud in response to the occurrence of certain events at network node 500 as the events happen. The event-driven data may be referred to herein as “oc-events.”

In some examples, the techniques of the disclosure may implement the following example equations (set forth below) for determining a radio power with which to configure a network device. Such equations enable an NMS, such as NMS 130 of FIGS. 1A-1B, to determine a radio power with which NMS 130 may configure one of APs 142A of FIG. 1. As set forth below, the determined radio power for, e.g., a particular AP such as AP 142A-1, is based at least in part on metrics of utilization and interference obtained for a plurality of APs 142A of wireless network 106A. NMS 130 may apply such equations of FIG. 1 as part of determining a radio power with which to configure AP 142A-1.

$${Rssi}^{j \to 1} = \frac{{Tx\_power}^{j}}{{d}_{ij}^{2}} \qquad ( 1 )$$

$${Util}_{{other}_{bss} , unknown , undecodable \times 2}^{{AP}_{i}} = {\sum }_{j}^{{AP}_{i}} {U}_{Tx , Rx \_ in \_ bss}^{{AP}_{i}} \cdot {f}^{decay} ( Tx\_power , distance ) \cdot f ( {Channel}_{distance} ) \qquad ( 2 )$$

$$f ( Tx\_power , distance , {Channel}_{distance} ) = f ( Tx\_power , distance ) \cdot f ( {Channel}_{distance} ) = {Tx}_{power} \cdot \frac{1}{{d}_{ij}^{2}} \cdot {δ}_{{ch}_{i} , {ch}_{j}} = {Tx}_{power} \cdot \frac{{Rssi}_{j \to 1}^{t - 1}}{{Tx\_power}^{t - 1}} \cdot {δ}_{{ch}_{i} , {ch}_{j}} \qquad ( 3 )$$

$${Tx\_power}^{t + 1} = {Tx\_power}^{t} + ΔTx\_power \qquad ( 4 )$$

$$Δ {Tx\_power}^{Util - demand} = \frac{Δ {Util}_{interference}}{\sum U \cdot \frac{Rssi}{{Tx\_power}^{j}}} \qquad ( 5 )$$

$${Tx\_power}^{t} : TX power in day - t \qquad ( 6 )$$

$${Tx\_power}^{t + 1 , neighbors} : f ( RF neighbors ) new RF update \qquad ( 7 )$$

$${Tx\_power}^{t + 1} = {Tx\_power}^{t + 1 , neighbors} + ( {Tx\_power}^{t} - {Tx\_power}^{t + 1 , neighbors} ) + Δ {Tx}_{power} = {Tx\_power}^{t + 1 , neighbors} + f ( {Tx\_power}^{t} , {Tx\_power}^{t + 1 , neighbors} , ΔTx\_power ) = {Tx\_power}^{t + 1 , neighbors} + \frac{{Tx\_power}^{t}}{{Tx\_power}^{t + 1 , neighbors}} \cdot ΔTx\_power \qquad ( 8 )$$

$${𝕄}_{interference} = {𝕄}_{usage} \times {𝔻}_{tx \_ power , distance , channel} \qquad ( 9 )$$

$$Δ {Tx\_power}^{Util - demand} = \frac{Δ {Util}_{interference}}{\sum U \cdot \frac{Rssi}{{Tx\_power}^{j}}} \qquad ( 10 )$$

$${Tx\_power}^{t + 1} = {Tx\_power}^{t + 1 , neighbors} + ( {Tx\_power}^{t} - {Tx\_power}^{t + 1 , neighbors} ) + Δ {Tx}_{power} = {Tx\_power}^{t + 1 , neighbors} + \frac{{Tx\_power}^{t}}{{Tx\_power}^{t + 1 , neighbors}} \cdot ΔTx\_power \qquad ( 11 )$$

The transmit power equations set forth above describe how radio power unit 135 of FIG. 1A may adjust a transmit power of an AP, such as APs 142 of FIG. 1A, over time in response to changes in network conditions. For example, radio power unit 135 may apply the power equations set forth above to calculate how much a transmit power should change (ΔTx_power) based on interference and utilization, and then updates the power level of the AP (Tx_power^{t+1}) accordingly. This updated power level takes into consideration both the expected behavior of neighboring APs 142 and a current power level of the AP under consideration, ensuring coordinated adjustments to minimize interference and improve performance. The term Tx_power^{t+1,neighbors} provides an estimate of an expected transmit power of neighboring APs in a next time interval. The term Tx_power^{t}/Tx_power^{t+1,neighbors} compares an AP's current power to its neighbors to adjust scaling. The term ΔTx_power is a power adjustment to be performed due to interference or utilization changes. The variables t and t+1 represent a current time interval and a next time interval, which depicts the evolution of transmit power over time.

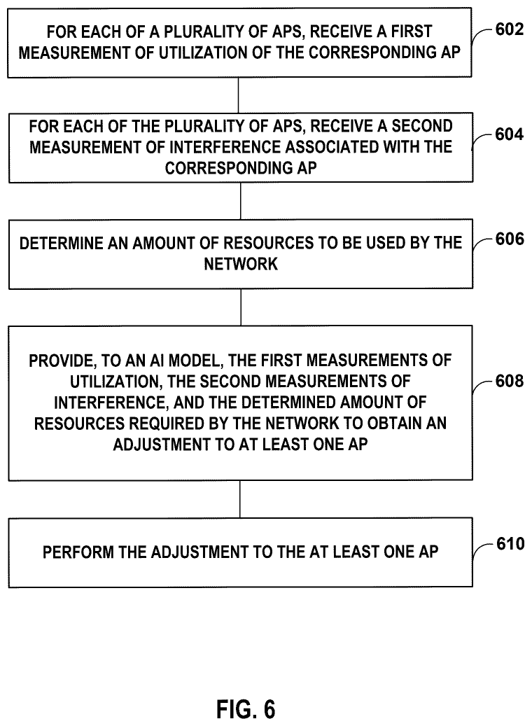

FIG. 6 illustrates an example operation performed in accordance with one or more techniques of this disclosure. For convenience, the operation of FIG. 6 is described with respect to NMS 300 of FIG. 3.

With respect to the operation of FIG. 6, radio power management unit 135 of VNA 133 of NMS 300 receives, for each of APs 142 of, e.g., wireless networks 106, a first measurement of utilization of the corresponding AP 142 (602). In some examples, the first measurement of utilization includes an indication of airtime that an AP 142 uses to transmit data to one or more clients associated with the AP 142. In some examples, the first measurement of utilization includes an indication of airtime that an AP 142 spends receiving data from one or more clients associated with the AP 142. In some examples, the first measurement of utilization includes an indication of airtime used by other APs 142 and their clients operating on a same channel as an AP 142 under consideration or an indication of a co-channel interference. In some examples, the first measurement of utilization includes an indication of airtime taken by other transmissions, such as Wi-Fi transmissions, and an AP 142 does not recognize as belonging to its BSS or any of the known neighbors of the AP 142. In some examples, the first measurement of utilization includes an indication of an amount of airtime that measures transmissions or messages received from another AP 142 that are undecodable. In some examples, the first measurement of utilization includes an indication of an airtime consumed by non-Wi-Fi sources of interference, such as Bluetooth devices, microwaves, or other electronics operating in the same frequency band, which an AP 142 can detect but not able to decode as a valid Wi-Fi message.

In addition, radio power management unit 135 receives, for each of APs 142 of, e.g., wireless networks 106, a second measurement of interference associated with the corresponding AP 142 (604). The second measurement of interference may indicate, e.g., an interference received by the one of APs 142A or an interference caused or induced by the one of APs 142A. In some examples, the second measurement of interference may be measured in, e.g., decibels. In some examples, the second measurement of interference comprises a Received Signal Strength Indicator (RSSI).

Radio power management unit 135 determines an amount of resources to be used by, e.g., wireless network 106A (606). For example, radio power management unit 135 may determine the amount of resources to be used by wireless network 106A based on various historical usage metrics and/or performance metrics associated with wireless network 106A. Radio power management unit 135 may determine, for example, a number of users or user devices historically active on wireless network 106A at each of a plurality of different time periods (e.g., such as each hour over a previous week or a previous month). As another example, an average amount of bandwidth historically consumed within wireless network 106A during each of the plurality of different time periods. In some examples, radio power management unit 135 may provide such historical usage metrics and/or performance metrics to an AI model to obtain an amount of resources predicted or forecasted to be to be used by wireless network 106A.

Radio power management unit 135 provides, to an AI model (such as AI model 380 of FIG. 3), the first measurements of utilization of APs 142, the second measurements of interference associated with APs 142, and the determined amount of resources to be used by wireless network 106A to obtain an adjustment to at least one AP 142 (608). In some examples, AI model 380 determines an adjustment to a configuration of a radio of the at least one AP 142, such as an adjustment to a power level of a radio of the at least one AP 142. In some examples, the determined adjustment comprises at least one of a maximum power level, a minimum power level, or a combination thereof, of one or more radios of the at least one AP 142.

Radio power management unit 135 performs the adjustment to the at least one AP 142 (610). For example, radio power management unit 135 configures a radio of the at least one AP 142 with a determined power level. As another example, radio power management unit 135 increases a first power level of a first radio of a first AP 142 and decreases a second power level of a second radio of a second AP 142.

The techniques described herein may be implemented in hardware, software, firmware, or any combination thereof. Various features described as agents, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software or hardware.

What is claimed is:

1. A computing device comprising:
storage media comprising instructions; and
processing circuitry configured to execute the instructions to cause the computing device to:
for each network device of a plurality of network devices of a network, receive a first measurement of utilization of the corresponding network device and a second measurement of interference associated with the corresponding network device;
determine an amount of resources to be used by the network;
provide, to an artificial intelligence (AI) model, the first measurements of utilization of the plurality of network devices, the second measurements of interference associated with the plurality of network devices, and the determined amount of resources to be used by the network to obtain an adjustment to at least one network device of the plurality of network devices; and
perform the adjustment to the at least one network device.

2. The computing device of claim 1, wherein, to perform the adjustment to the at least one network device, the instructions cause the computing device to adjust a configuration of a radio of the at least one network device.

3. The computing device of claim 2, wherein, to adjust the configuration of the radio of the at least one network device, the instructions cause the computing device to adjust a power level of the radio of the at least one network device.

4. The computing device of claim 2, wherein, to adjust the configuration of the radio of the at least one network device, the instructions cause the computing device to adjust at least one of a maximum power level, a minimum power level, or a combination thereof, of the radio of the at least one network device.

5. The computing device of claim 2, wherein the computing device is configured to perform the adjustment to the configuration of the radio of the at least one network device to reduce interference within the network.

6. The computing device of claim 1, wherein, to perform the adjustment to the at least one network device, the instructions cause the computing device to:
increase a first power level of a first radio of a first network device of the plurality of network devices; and
decrease a second power level of a second radio of a second network device of the plurality of network devices.

7. The computing device of claim 1, wherein the first measurement of utilization of each network device of the plurality of network devices comprises one or more of:
a measurement of channel utilization used for transmitting by the network device;
a measurement of channel utilization used for receiving by the network device;
a measurement of channel utilization used by devices other than the network device;
a measurement of channel utilization of Wifi messages associated with devices unknown to the network device;
a measurement of channel utilization of Wifi messages undecodable by the network device; or
a measurement of channel utilization of non-Wifi messages received by the network device.

8. The computing device of claim 1, wherein the second measurement of interference associated with each network device of the plurality of network devices comprises one or more of:
an interference received by the network device; or
an interference induced by the network device.

9. The computing device of claim 1, wherein the plurality of network devices comprise a plurality of access points (APs).

10. The computing device of claim 9, wherein the network comprises an ultra-high density mesh network comprising the plurality of network devices.

11. A method comprising:
for each network device of a plurality of network devices of a network, receiving, by processing circuitry of a computing device, a first measurement of utilization of the corresponding network device and a second measurement of interference associated with the corresponding network device;
determining, by the processing circuitry, an amount of resources to be used by the network;
providing, by the processing circuitry, to an artificial intelligence (AI) model, the first measurements of utilization of the plurality of network devices, the second measurements of interference associated with the plurality of network devices, and the determined amount of resources to be used by the network to obtain an adjustment to at least one network device of the plurality of network devices; and
performing, by the processing circuitry, the adjustment to the at least one network device.

12. The method of claim 11, wherein performing the adjustment to the at least one network device comprises adjusting a configuration of a radio of the at least one network device.

13. The method of claim 12, wherein adjusting the configuration of the radio of the at least one network device comprises adjusting a power level of the radio of the at least one network device.

14. The method of claim 12, wherein adjusting the configuration of the radio of the at least one network device comprises adjusting at least one of a maximum power level, a minimum power level, or a combination thereof, of the radio of the at least one network device.

15. The method of claim 12, wherein performing the adjustment to the configuration of the radio of the at least one network device is to reduce interference within the network.

16. The method of claim 11, wherein performing the adjustment to the at least one network device comprises:
increasing a first power level of a first radio of a first network device of the plurality of network devices; and
decreasing a second power level of a second radio of a second network device of the plurality of network devices.

17. The method of claim 11, wherein the first measurement of utilization of each network device of the plurality of network devices comprises one or more of:
a measurement of channel utilization used for transmitting by the network device;
a measurement of channel utilization used for receiving by the network device;
a measurement of channel utilization used by devices other than the network device.

18. The method of claim 11, wherein the first measurement of utilization of each network device of the plurality of network devices comprises one or more of:
a measurement of channel utilization of Wifi messages associated with devices unknown to the network device;
a measurement of channel utilization of Wifi messages undecodable by the network device; or
a measurement of channel utilization of non-Wifi messages received by the network device.

19. The method of claim 11, wherein the second measurement of interference associated with each network device of the plurality of network devices comprises one or more of:
an interference received by the network device; or
an interference induced by the network device.

20. A computing system comprising:
storage media comprising instructions; and
processing circuitry configured to execute the instructions to cause the computing system to:
for each network device of a plurality of network devices of a network, receive a first measurement of utilization of the corresponding network device and a second measurement of interference associated with the corresponding network device;
determine an amount of resources to be used by the network;
provide, to an artificial intelligence (AI) model, the first measurements of utilization of the plurality of network devices, the second measurements of interference associated with the plurality of network devices, and the determined amount of resources to be used by the network to obtain a power level of a radio of at least one network device of the plurality of network devices; and
configure the radio of the at least one network device with the determined power level.
